(19) United States
(12) Patent Application Publication
(10) Pub. No.: US 2014/0304690 A1
(43) Pub. Date: Oct. 9, 2014

(54) Systems and Methods for Outputting an Application to Another Environment

(71) Applicants: Tim Wohlberg, Hamburg (DE); Klaas Stoeckmann, Hamburg (DE); Kai Ortmanns, Stelle (DE); Soeren Ammedick, Neumuenster (DE)

(72) Inventors: Tim Wohlberg, Hamburg (DE); Klaas Stoeckmann, Hamburg (DE); Kai Ortmanns, Stelle (DE); Soeren Ammedick, Neumuenster (DE)

(73) Assignee: Adobe Systems Incorporated, San Jose, CA (US)

(21) Appl. No.: 12/127,435

(22) Filed: May 27, 2008

(51) Int. Cl. G06F 9/45

(52) U.S. Cl. 717/136

(57) ABSTRACT

Methods for outputting an application are disclosed. One exemplary embodiment provides a software tool for outputting an application to one or more environments. The tool may be able to receive and use output task plug-ins that specify output characteristics for outputting to different environments. The use of such plug-ins may make the tool easily extensible with respect to outputting an application to many different mobile devices, including devices that are not yet released, as well as to other local, device, and network environments. Another exemplary embodiment involves a output tool that may receive and save user specified output parameters for an output task as an output task instance. The tool makes the output task instance available for outputting an application according to the received output parameters without requiring that the parameters be specified again.

### FIELD

Embodiments relate generally to the field of computing and specifically to computing applications used on multiple computing environments.

### BACKGROUND

Many computer and other electronic device users occasionally or frequently desire to send a file or other electronic application to a connected device, such as a wirelessly-connected cellular phone. For example, a user may send a game from his or her personal computer to his or her cell phone. More generally a user may want to output an application from one environment, such as an application development environment, to other environments, including to external testing environments. The term “environment” is used broadly and encompasses, as examples, mobile devices, network storage locations, local storage locations, and other locations external to the software application from which an application is being outputted, among other things. The term “application” is also used broadly and encompasses any content that can be executed, displayed, or used in a one or more environments, including packaged applications that comprise multiple components.

Existing output tools, including those provided by computing operating systems, generally lack features that adequately facilitate outputting to one or more environments. For example, developing a software application may require outputting to multiple environments (e.g., many different cellular phones), outputting multiple times under similar constraints (e.g., to the same cellular phone every time a change to an application is tested), outputting to a file, and/or outputting to an file transfer protocol (FTP) location, among other things. Such outputting may be complicated because many software applications are created to be compatible with differing devices, having differing processing capabilities, architecture, computing language(s), hardware (e.g., screen resolutions, color depth, etc.) and/or software configurations (e.g., data formatting, firmware, operating systems, etc.). For example, a game executed on one cellular telephone also may need to execute on a particular personal data assistant (PDA) and on a user's desktop computer.

### SUMMARY

Methods for outputting an application are disclosed. In one embodiment, the method includes providing a computer software tool for outputting an application to one or more environments, receiving a received output task plug-in specifying output characteristics for outputting to an environment associated with the output task plug-in, making an output task available for use on the computer software tool, receiving a command to perform the output task, and outputting the application from the computer software tool to the environment associated with the output task plug-in according to the output characteristics.

One embodiment involves a method that comprises providing a computer software tool for outputting an application to one or more environments, providing an interface for specifying output parameters associated with an output task, receiving output parameters at the interface, saving the output parameters as an output task instance, and making the output task instance available on a computer software tool for outputting an application according to the received output parameters without requiring that the parameters be specified again.

These illustrative embodiments are mentioned not to limit or define the invention, but to provide examples to aid understanding thereof Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a system diagram illustrating an illustrative outputting system according to certain embodiments;

FIG. 2 illustrates an exemplary user interface 200 for an application development tool according to certain embodiments;

FIG. 3 illustrates an exemplary user interface for a device manager for use with the application development tool of FIG. 2, according to certain embodiments;

FIG. 4 illustrates an exemplary user interface for a device manager for use with the application development tool of FIG. 2, according to certain embodiments;

FIG. 5 illustrates an exemplary user interface for a device manager for use with the application development tool of FIG. 2, according to certain embodiments;

FIG. 6 illustrates an exemplary user interface for a device manager for use with the application development tool of FIG. 2, according to certain embodiments;

FIG. 7 illustrates an exemplary method of providing a plug-in capable computer software tool for outputting an application according to certain embodiments; and

FIG. 8 illustrates an exemplary method of providing a task-instance capable computer software tool for outputting an application according to certain embodiments.

### DETAILED DESCRIPTION OF EXEMPLARY EMBODIMENTS

Embodiments provide methods and systems for outputting an application. One exemplary embodiment provides a software tool for outputting an application to one or more environments. The tool is able to receive and use output task plug-ins that specify output characteristics for outputting to different environments. The use of such plug-ins may make the tool easily extensible with respect to outputting an application to many different mobile devices, including devices that are not yet released, as well as to other local, device, and network environments. Another exemplary embodiment involves an output tool that receives and saves user specified output parameters for an output task as an output task instance. The tool makes the output task instance available for outputting an application according to the received output parameters without requiring that the parameters be specified again.

### Illustrative Software Tool Used in the Exemplary Context of Developing an Application for Different Mobile Devices

The following specific illustrative embodiment is provided to illustrate some of the applications, uses, and benefits of certain of the techniques for outputting an application described herein.

An application developer wanting to provide his or her developed application on different computing environments may face several challenges. To facilitate providing the application on many computing environments, the developer may use an software tool that allows him to test or emulate the application for different environments prior to outputting the application to physical devices for testing. When it comes time to test the application on physical devices, the developer may use a device manager software tool to facilitate outputting the application to different devices.

In this example, the application developer uses the device manager software tool to create a project that acts as a container for all of the assets associated with an application. Once the project is created, the developer adds different asset resources to the project, specifically adding files to be included in the application that will be outputted. For example, the developer may include a .swf file and various other files used by the .swf file. The developer is also able to identify different devices using the software tool and include the identities of those identified devices in the project. The developer identifies each of the mobile devices upon which the application will be tested.

Once the application and device assets have been associated with the project, the developer is able to run an output task to output the application to another environment. As an example, the developer first outputs the application to a mobile device that is connected to the developer's computer via a wireless connection. To do so, the developer executes an output-to-local-device task and specifies the name (identity) of the particular device to which the application will be outputted. The developer may specify other parameters as well, for example, the identify of which assets of the project will be included in the outputted application. The developer saves these parameters as part of a first output task instance.

After performing the output task, the developer next desires to output the same application to another connected mobile device, but realizes that none of the software tool's existing output tasks supports output to the particular model mobile device. The developer searches on the Internet and finds an output task plug-in for the particular model mobile device. The plug-in is downloaded and plugged into the software tool. Once the plug-in is available, the developer performs the associated output task and outputs the application to the attached mobile device. To do so, the developer provides output preferences or other parameters, and saves these output parameters as part of a second output task instance. This instance is also saved as part of the project in the tool.

After outputting to the two mobile devices, the developer tests the application on each of the devices and decides to make a change to the application on his or her application development tool. Once the change is made, the developer is able to again output the application to each of the two wirelessly attached mobile devices. Since the first and second output task instances are available, the developer can simply execute these task instances to re-execute the associated output tasks without having to again specify the output parameters. Over the course of developing the application, the application is changed and tested hundreds of times, and the developer is able to realize significant time saving using the output software tools plug-in and task instance features.

Similar to creating instances for output tasks related to physical devices, the developer may create a task instance for a copy-to-FTP task that includes a specified FTP address, password, and any other output parameters. The developer could then share this project, including the FTP task instance, with other developers. These developers may use the common task to ensure consistent backup during development, e.g., that it is always in the same location on the FTP server, among other things.

These illustrative examples are given to introduce the reader to the general subject matter discussed herein and are not intended to limit the scope of the disclosed concepts. The following sections describe various additional embodiments and examples of methods and systems.

### Exemplary Outputting System

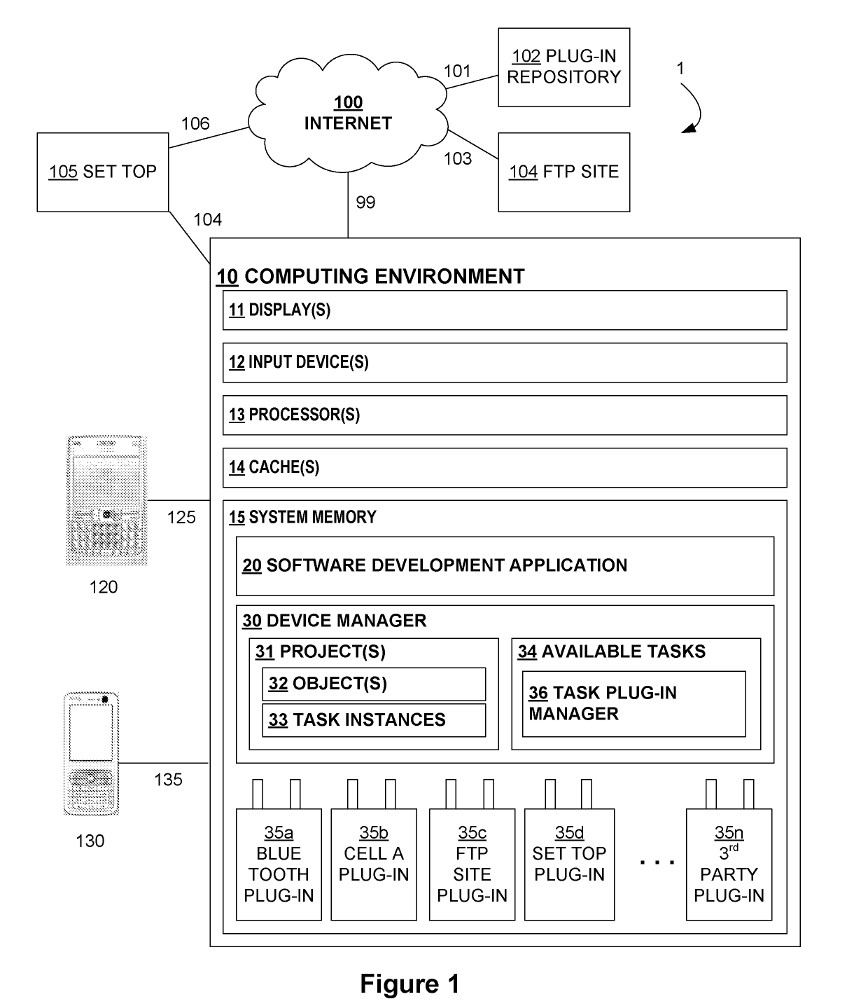

Referring now to the drawings in which like numerals indicate like elements throughout the several Figures, FIG. 1 is a system diagram illustrating an illustrative outputting system according to certain embodiments. Other embodiments may be utilized. The system 1 shown in FIG. 1 comprises a computing device 10 connected through a network, such as the Internet 100, to various devices 10, 105, 102, 105, as well as locally connected to physical mobile devices 120, 130. These connections 99, 104, 106, 101, 103, 125, 135 may be wired or wireless.

The computing device 10 comprises one or more displays 11, input devices 12, processors 13, caches 14, and system memory 15. The system memory 15 comprises a software development application 20 and a device manager 30. In certain embodiments the device manager 30 is implemented as a portion of the software development application 20. The device manage 30 comprises a project(s) functionality 31 and an available tasks functionality 34.

The project(s) 31 functionality allows a user to create a project that can contain asset object(s) 32 associated with an application that will be outputted via a given task from the device manager 30/software development application 20 to a different environment such as another location of memory, to an FTP site, and/or to a connected device. A project may include task instance(s), which specify (typically from user input) one or more parameters associated with performing a task in a particular case. A project may also include the identities of different devices (e.g., attached mobile devices that may have profiles within the project), among other things.

The available tasks functionality 34 allows the device manager to output an application via tasks that are not necessarily specified by the device manager itself The tasks may be specified by one or more task plug-ins 35a-n that are interpreted by a task plug-in manager 36 to implement a given output function. For example, a plug-in may relate to general Bluetooth output task 35a, output to a particular cell phone as shown by the cell A plug-in 35b, to a user (or parameter) specified FTP site 104 as shown by the FTP site plug-in 35c, or to a particular set top box 105 as shown by set top box plug-in 35d. As more specific examples, the Bluetooth plug-in 35a might be used to output generically to a device 120 connected to the computing environment 10 through a Bluetooth connection 125. Such a task may be generic in the sense that it may apply to a variety of such devices. The cell A plug-in 35c, on the other hand, may relate to a particular model cell phone 130, or to a small subset of similar mobile devices, e.g., those having a particular operating system, etc. Such devices may be connected the computer environment via any suitable connection 135, including by Bluetooth or otherwise. Thus, a plug-in may specify a given attribute while another plug-in may allow a user to specify that attribute as a parameter, e.g. the connection type in the present examples.

A plug in can be any component usable Some of the plug-ins 35a-n may have been provided with the device manager, while others may be incorporated at a later point in time. For example, plug-ins may be downloaded from a remotely located plug-in repository 102. by A developer may want to test an application on a particular device and simply go to the device manufacturer's (or other third party's) web site and download an appropriate plug-in. Plug-ins also provide powerful functionality for third parties to particularize and extend the output functionality provided by the device manager 30 to encompass new devices, environments, and other technologies.

### Exemplary User Interfaces

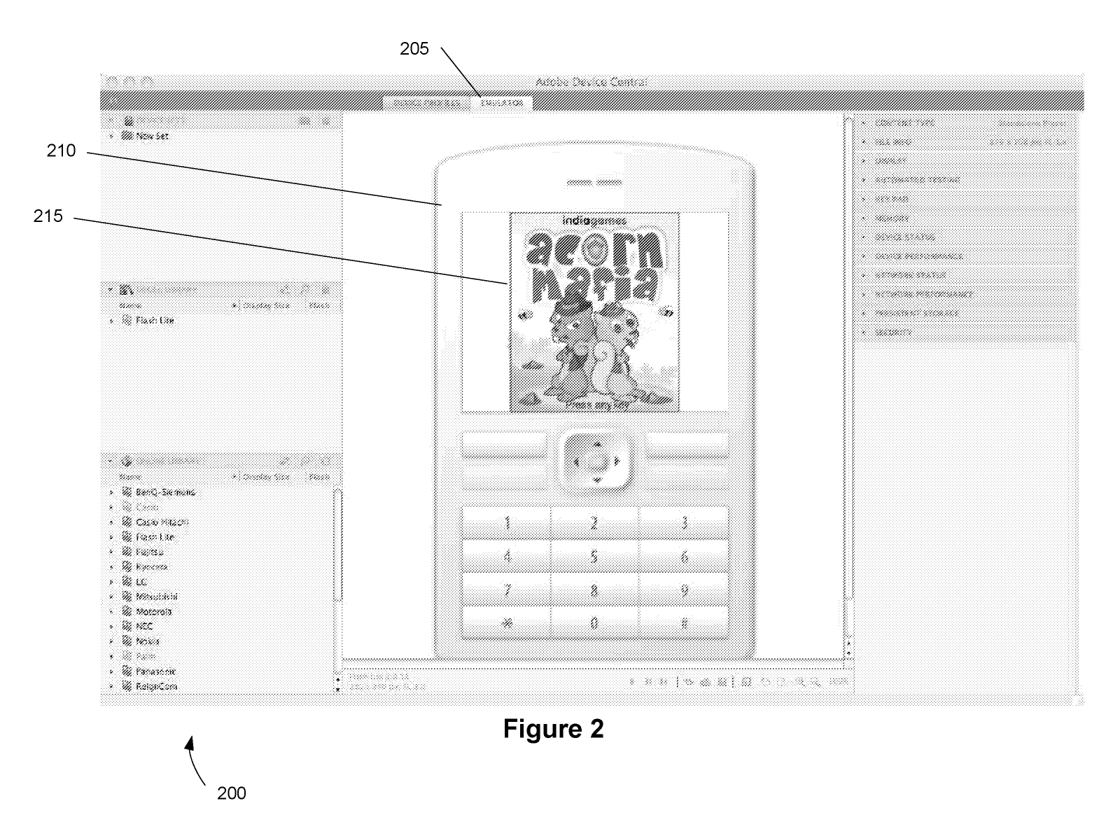

FIG. 2 illustrates an exemplary user interface 200 for an application development tool according to certain embodiments. The interface 200 comprises an emulator that allows a user to emulate the running of an application on the development machine itself. Here an image of the device being emulated 210 is displayed and the application is emulated within an emulation area 215, corresponding to the screen of the device. Certain embodiments of the present disclosure will not involve an application development tool and/or will not involve an emulator.

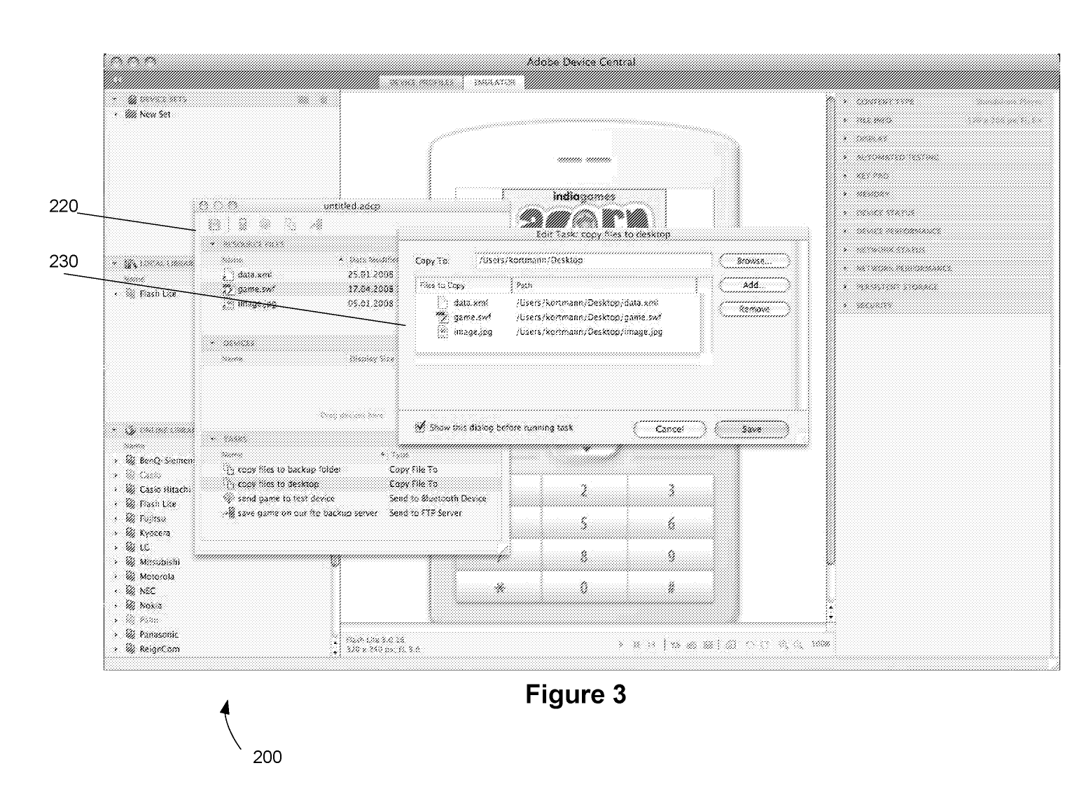

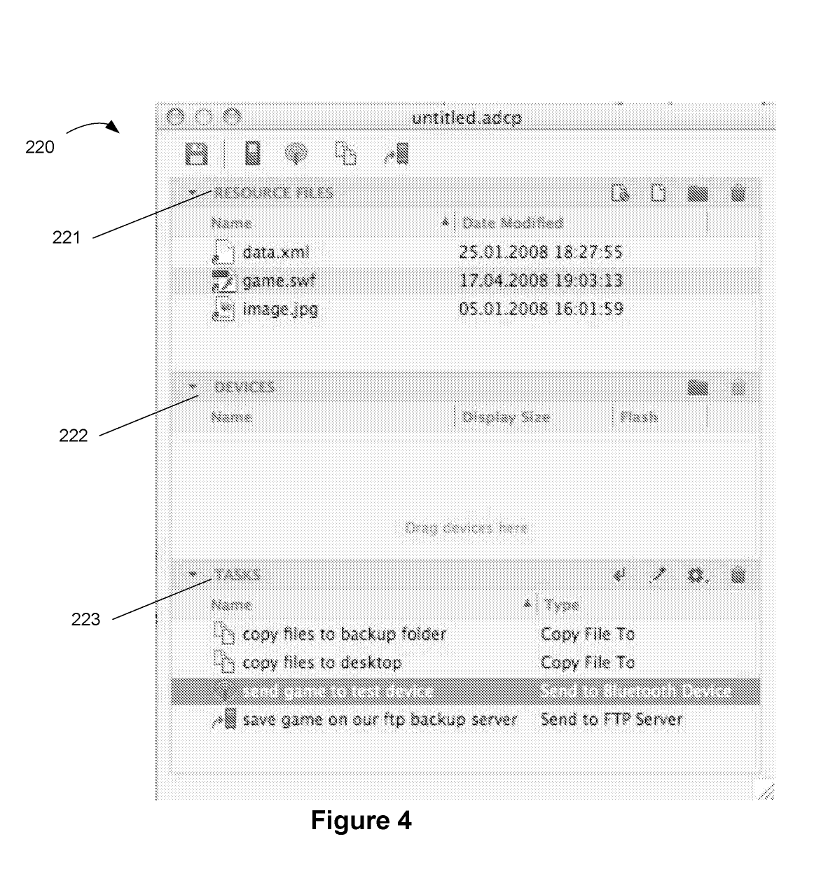

FIGS. 3-6 illustrates an exemplary user interface for a device manager for use with the application development tool of FIG. 2, according to certain embodiments. The interface includes a project(s) tool 220 that allows a user to organize assets or resources 221 of an application, devices 222, and output task instances 223 under a single conceptual grouping, i.e., a project.

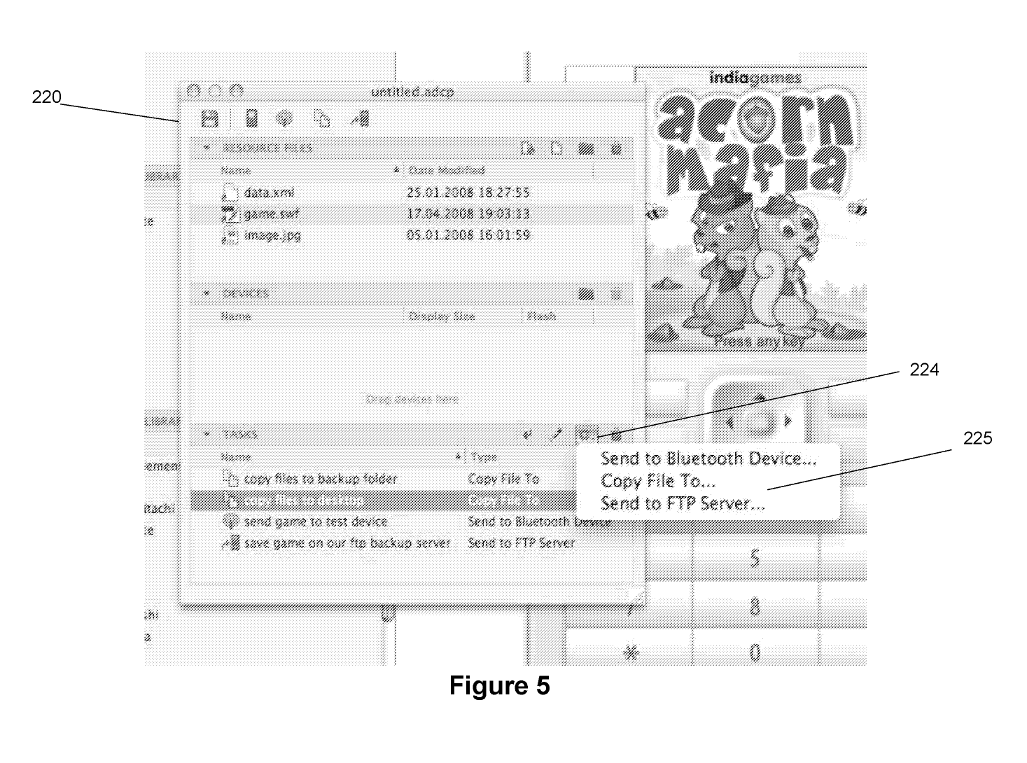

A user is able to execute a task, as shown in FIG. 5, by selecting a tasks function 224 and selecting from a list 225 of output task types. These output task types may correspond to the specific plug-ins that have been identified in the device manager.

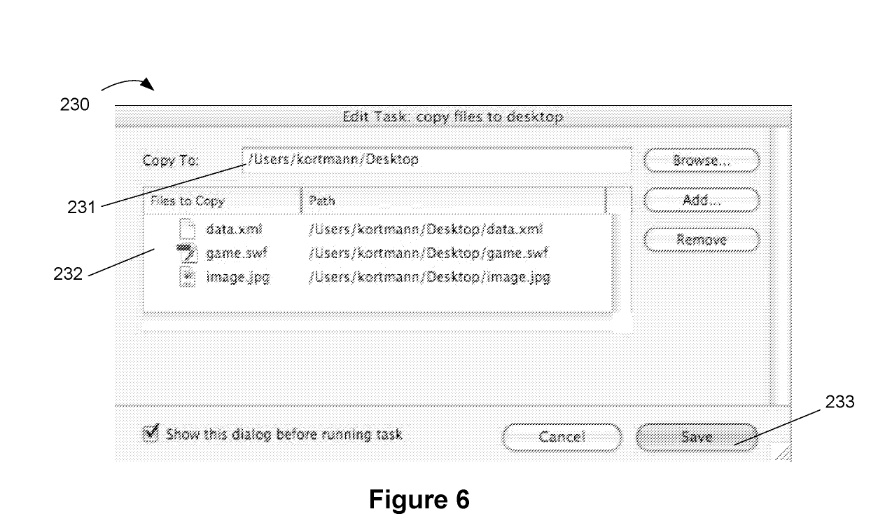

Once a task type is selected, the interface provides a parameter entry screen, that allows the user to enter parameters and then save the task/parameter combination as a task instance. For example, as shown in FIG. 6, a copy-files-to-desktop task instance parameter entry screen 230, depicted in FIG. 6, includes a copy-to parameter and a files-to-copy parameter.

### Exemplary Plug-In Methods and Systems

Certain embodiments provide a plug-in architecture which allows plug-in output task to be added to a device managing tool. For example, it may allow a third party to add more services related to dedicated mobile devices, i.e., those that require more than standard outputting tasks provide and others. It allows a user or a third party to create and use a new service without necessarily modifying the software development product or output architecture itself, for example by providing a particular script file to a specified location known by the output architecture. As an example, a new type of output service might be created to send an application to a particular television set top box. As another example, a new task could be provided to install an Adobe® Flash® application on a particular Nokia® device that packages the application to comply with the particular requirements of the device. If the application assets include the executable aspect of application, a text file, and two associated images, the output task could package these multiple assets into a single package that the device will be able to use.

Certain embodiments provide a device managing tool having an architecture that facilitates packaging plug-ins by providing an interface, such as the project centric interface, that allows a user to manage a group of related assets and easily identify such assets for use by a particular output task, where the output task particulars can be specified by a plug-in module.

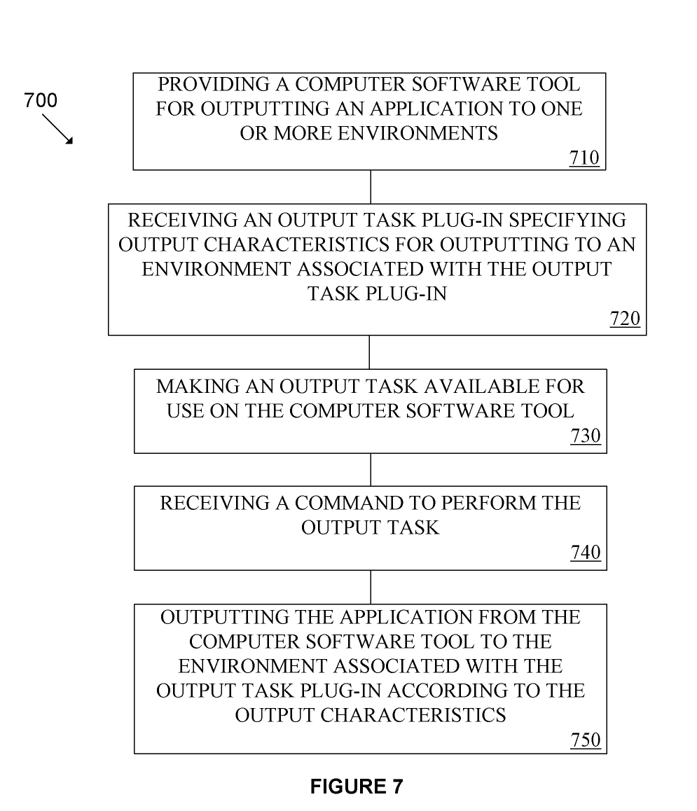

FIG. 7 illustrates an exemplary method 700 of providing a plug-in capable computer software tool for outputting an application, according to certain embodiments. The method 700 is computer implemented and involves providing a computer software tool for outputting an application to one or more environments, as shown in block 710. The computer software tool may or may not be associated with application development software. The computer software tool may or may not provide an interface for organizing component assets for a packaged-application.

The method 700 further involves receiving a received output task plug-in specifying output characteristics for outputting to an environment associated with the output task plug-in, as shown in block 720. The output task plug-in may specify output characteristics for a particular device (such as a cell phone of a particular model), for packaging an application, for packaging an application for a particular device, for a specific file location, and/or for a specific network or local address, among other things. An output task plug-in may be included originally or after the original implementation of the software tool. For example, one may be received over the Internet, including but not limited to, from a party other than the party providing the computer software tool. An output task plug-in may be manually found by a user searching the Internet, automatically found by a module within the computer software tool (e.g., when a user includes a device as part of a project), or located in any other manner. An output task plug-in may be provided from a local storage medium, such as from a CD provided with a mobile device. It may be identified and/or retrieved by a variety of mechanisms, some involving and others not involving user interaction and/or network access.

The method 700 further involves making an output task available for use on the computer software tool, as shown in block 730. The output task corresponds to the outputting to the environment associated with the output task plug-in.

The method 700 further involves receiving a command to perform the output task, as shown in block 740. For example, it may receive a command from a user or from a batch application to perform a particular output task once or multiple times.

The method 700 further involves outputting the application from the computer software tool to the environment associated with the output task plug-in according to the output characteristics, as shown in block 750. This outputting may or may not involve the creation of a packaged application that comprises several component assets. In the case of a packaged application, the output task plug-in and/or user supplied parameters may provide information used in creating the packaged application from several components.

### Exemplary Plug-Ins

An output task plug-in can be anything that provides information that can be used to perform or facilitate an output task, including information about output task implementation details. A plug-in may be provided and/or received in a variety of ways, including from both remote and local components. The plug-in can be stored locally, remotely, incorporated into an outputting program, or need not be stored at all. For example, information my be extracted from a plug-in and used by an outputting program.

Certain embodiments involve a device manager that reads one or more output task plug-ins at run time to extract and dynamically use output task implementation details. For example, a plug-in might be an XML file that provides such information. As another example a plug-in might comprise both (a) an XML file that provides information and (b) a script file. In this example, a device manager may read the XML file at runtime and recognize that it needs to launch the script file (e.g., by linking to Java script or other script file provided as part of the plug-in).

More generally, an exemplary XML-type plug-in file, is provided below to illustrate a “copy file to” output task plug-in.

```
  <?xml version=“1.0” encoding=“UTF-8” ?>
- <adat:task xmlns:adat=“http://ns.adobe.com/devicecentral/task/”
  xmlns:xsi=“http://www.w3.org/2001/XMLSchema-instance”
  xsi:schemaLocation=“http://ns.adobe.com/devicecentral/task/
  adat.xsd”
  guid=“5cff2c68-96b3-11dc-8314-0800200c9a68” version=“1”>
  - <general>
  <title value=“$$$/SendTo/Title/CopyFileTo=Copy File To” />
  <menuItem value=“$$$/SendTo/Menu=Copy File To...” />
  <toolTip value=“$$$/SendTo/ToolTip=Copy file to” />
  <script path=“FileCopy.jsx” />
  <icon path=“copy.png” />
  <toolbar value=“true” />
  <localization path=“CopyFile.zstrings” />
  </general>
- <dialog height=“253” width=“510” minWidth=“510”
    minHeight=“160”>
- <container layout=“horizontal” sizex=“scale”>
- <staticText alignment=“left” width=“75”>
      <label value=“$$$/SendTo/UI/Destination=Copy To:” />
    </staticText>
    <textField id=“target” width=“305” sizex=“scale” />
- <button onClick=“doSelectTargetFolder” width=“95” sizex=“right”>
        <label value=“$$$/SendTo/UI/Button/Browse=Browse...” />
    </button>
  </container>
- <container layout=“horizontal” sizex=“scale”>
- <fileList id=“files” width=“380” height=“120” sizex=“scale”
    icon=“path”>
- <columns>
      <column dataField=“filename”
        columnText=“$$$/SendTo/UI/FilesToCopy=Files to Copy”
        width=“120” />
      <column dataField=“path” columnText=“$$$/SendTo/UI/
      Path=Path”
        width=“230” />
    </columns>
  </fileList>
- <container layout=“vertical” sizex=“right”>
- <button onClick=“doAddFile” width=“95”>
        <label value=“$$$/SendTo/UI/AddFile=Add...” />
    </button>
- <button onClick=“doRemoveFile” width=“95” id=“btnRemove”>
        <label value=“$$$/SendTo/UI/RemoveFile=Remove” />
        </button>
      </container>
    </container>
  </dialog>
  </adat:task>
```

### Exemplary Task Instance Method

Certain embodiments relate to output task automation and semi-automation. The significance of this is illustrated in cases of application development, where a developer is developing content part of the development cycle may entail making changes and then testing or retesting on one or more physical devices, e.g., on a mobile phone. In many cases developers will have to do this repeatedly and with little variation aside from the changes made to the application itself. A developer may be able to write his or her own output task plug-in and then specify case specific parameters in a saved task instance. This gives a developer flexibility on multiple levels and facilitates his or her ability to reduce or eliminate redundancy in his or her development and testing processes.

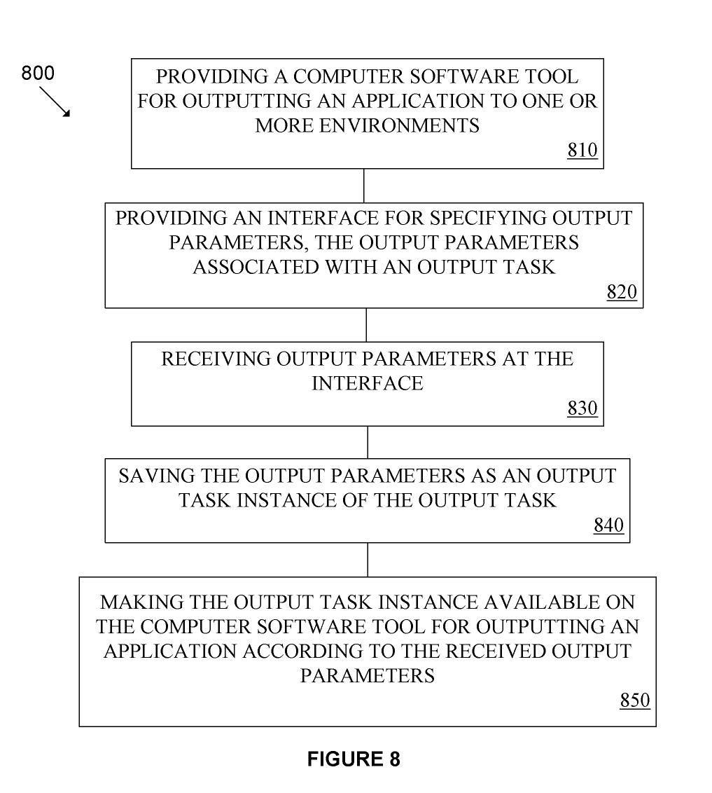

FIG. 8 illustrates an exemplary method 800 of providing a task-instance capable computer software tool for outputting an application, according to certain embodiments. The method 800 is computer implemented and involves providing a computer software tool for outputting an application to one or more environments, as shown in block 810. The computer software tool may or may not be associated with application development software. The computer software tool may or may not provide an interface for organizing component assets for a packaged-application.

The method 800 further involves providing an interface for specifying output parameters, the output parameters associated with an output task, as shown in block 820, and receiving output parameters at the interface, as shown in block 830. The output parameters may specify a particular output device, an attribute of a particular output device, and/or an attribute for executing an application on a particular output device, among other things.

The method 800 further involves saving the output parameters as an output task instance of the output task, as shown in block 840.

The method 800 further involves making the output task instance available on the computer software tool for outputting an application according to the received output parameters without requiring that the parameters be specified again, as shown in block 850. For example, the task instance may be available as an entry in a list or a button that a user may select or otherwise execute.

### General

Certain embodiments relate to outputting an application to a different environment. These are merely illustrative. In short, the techniques and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown in FIG. 1 as functional or storage components on the respective devices. As is known to one of skill in the art, such applications may be resident in any suitable computer-readable medium and execute on any suitable processor. For example, the devices 10, 102, 104, 105, 120, 130 shown each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

While the network 100 shown in FIG. 1 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs. Similarly, the server devices depicted as single computer systems, may be implemented as a network of computers or processors. Examples of a server device are servers, mainframe computers, networked computers, a processor-based device, and similar types of systems and devices.

1. A computer-implemented method, comprising:
receiving an output task plug-in specifying output implementation details for outputting to an environment associated with the output task plug-in, the output task plug-in received at a computer software tool for outputting an application to one or more environments, the output implementation details being related to packaging the application for a particular device associated with the environment;
providing an interface for a user to define an output task associated with the output task plug-in, wherein the interface is provided on the computer software tool and enables the user to associate one or more files to be packaged in the application with the defined output task, and wherein execution of the output task results in output of the application to the environment;
receiving, from the user of the interface, indication of the one or more files to be packaged in the application;
making the output task available for use on the computer software tool;
in response to receiving an indication of selection of the output task:
creating a packaged application comprising the one or more files associated with the output task in accordance with the output implementation details specified by the output task plug-in; and
outputting the packaged application from the computer software tool to the environment associated with the output task plug-in in accordance with the output implementation details.

2-4. (canceled)

5. The method of claim 1, wherein the computer software tool is associated with application development software.

6. (canceled)

7. The method of claim 1, wherein the particular device is a cell phone of a particular model.

8. The method of claim 1, wherein the output task plug-in is received over the Internet from a party other than the party providing the computer software tool.

9. A computer-implemented method, comprising:
providing, to a user, an interface to define an output task associated with an output task plug-in, wherein the interface is associated with a computer software tool for outputting an application to a device and enables the user to associate one or more files to be packaged in the application with the defined output task, wherein the user-defined output task is associated with multiple files to be packaged in the application, and wherein the user-defined output task comprises a task that, when executed, outputs the application to the device;
receiving from the user of the interface, indication of the one or more files to be packaged in the application;
associating the indicated one or more files with the user-defined output task; and
making the user-defined output task available on the computer software tool.

10. The method of claim 9, further comprising providing a project interface for managing a project, the project interface allowing identification of components for inclusion in the project.

11. The method of claim 10, wherein the indicated one or more files specify one or more components identified in the project for outputting as a packaged application.

12. (canceled)

13. The method of claim 9, wherein the indicated one or more files specify an attribute of a particular output device.

14. The method of claim 9, wherein the indicated one or more files specify an attribute for executing the application on a particular output device.

15. The method of claim 9, wherein the computer software tool is associated with application development software.

16. A system comprising:
a graphical user interface for receiving an indication of one or more files to be packaged into a packaged application, wherein the indicated one or more files are associated with a user-defined output task;
an outputting module for implementing the user-defined output task that outputs the packaged application to multiple environments; and
an output task plug-in manager for receiving output task plug-ins specifying output implementation details for outputting to the multiple environments and interpreting the output task plug-ins, using a processor, to provide code for outputting the packaged application to the multiple environments in accordance with the output implementation details, the output implementation details being related to packaging the indicated one or more files into the packaged application for multiple devices, each device associated with one of the multiple environments.

17. The system of claim 16, wherein the computer software tool is associated with application development software.

18. The system of claim 16, wherein the output task plug-in specifies the output implementation details for a particular device.

19. The system of claim 16, wherein the computer software tool comprises an interface for organizing components for the packaged-application.

20. The system of claim 16, wherein the output task plug-in manager is able to interpret plug-ins comprising extensible markup language.

21. A non-transitory computer-readable medium on which is encoded:
program code for providing a computer software tool for outputting an application to one or more environments;
program code for receiving an output task plug-in specifying output implementation details for outputting to an environment associated with the output task plug-in, the output implementation details being related to packaging the application for a particular device associated with one of the environments;
program code for providing an interface for defining the output task associated with the output task plug-in, wherein the interface is provided on the computer software tool and enables a user to associate one or more files to be packaged in the application with the defined output task, and wherein execution of output task results in the output of the application to the environment;
program code for making the output task available for use on the computer software tool;
program code for receiving an indication of selection of the output task;
program code for creating a packaged application comprising the one or more files associated with the output task in accordance with the output implementation details specified by the output task plug-in; and
program code for outputting the packaged application from the computer software tool to the particular device in accordance with the output implementation details.

22. A non-transitory computer-readable medium on which is encoded program code, the program code comprising:
program code for providing a computer software tool for implementing a user-defined output task, the user-defined output task comprising outputting an application to one or more environments;
program code for providing an interface to define the user-defined output task associated with an output task plug-in, wherein the interface is provided on the computer software tool and enables a user to associate one or more files to be packaged in the application with the defined output task, and wherein execution of the user-defined output task results in output of the application to the environment;
program code for receiving, from the user of the interface, indication of the one or more files;
program code for associating the indicated one or more files with the user-defined output task; and
program code for making the user-defined output task available for outputting an application according to the indicated one or more files.

23. The method of claim 9, further comprising:
determining whether a second user-defined output task, associated with a second output task plug-in, is saved;
responsive to the determination that the second user-defined output task is saved, making the second user-defined output task available for outputting the application according to a plurality of second one or more files associated with the second user-defined output task;
responsive to the determination that the second user-defined output task is not saved:
providing a second interface to define the second user-defined output task associated with the second output task plug-in, wherein the second interface is provided on the computer software tool and enables the user to associate a set of files to be packaged in the application with the second user-defined output task, and wherein execution of the second user-defined output task results in the output of the application to a different environment;
receiving from the user of the second interface, indication of the set of files different than the one or more files, the set of files to be packaged in the application;
associating the different set of files with the second user-defined output task; and
making the second user-defined output task available for outputting the application according to the second user-defined output task.

24. The method of claim 1, wherein the output implementation details relate to packaging the application for the particular device.

25. The method of claim 9, wherein the interface is provided on a different device than the device to which the application is outputted.

26. The method of claim 1, wherein the defined output task has an output task type that is indicative of the output task plug-in associated with the defined output task.

27. The method of claim 1, further comprising associating the one or more files with the defined output task.
